(19) United States
(12) Patent Application Publication
(10) Pub. No.: US 2018/0203663 A1
(43) Pub. Date: Jul. 19, 2018

(54) Distributed Audio Capture and Mixing Control

(71) Applicant: Nokia Technologies Oy, Espoo (FI)

(72) Inventors: Arto Lehtiniemi, Lempaala (FI); Antti ERONEN, Tampere (FI); Sujeet Shyamsundar MATE, Tampere (FI)

(21) Appl. No.: 15/742,709

(22) PCT Filed: Jul. 5, 2016
(86) PCT No.: PCT/FI2016/050495

§ 371 Date: Jan. 8, 2018

(30) Foreign Application Priority Data
Jul. 8, 2015 (GB) 1511949.8
Jul. 27, 2015 (GB) 1513198.0
Oct. 12, 2015 (GB) 1518023.5
Oct. 12, 2015 (GB) 1518025.0
Nov. 30, 2015 (GB) 1521098.2

(51) Int. Cl. G06F 3/16; H04S 7/00; G06F 3/0346

(52) U.S. Cl. CPC G06F 3/162; G06F 3/165; G06F 3/167; G06F 2203/0381; G06F 3/0346; H04S 2400/15; H04S 2400/11; H04S 7/303

(57) ABSTRACT

Apparatus including: a locator configured to determine at least one media source location; a user interface configured to generate at least one user interface element associated with the at least one media source; the user interface further configured to receive at least one user interface input associated with the user interface element; a media source controller configured to manage control of at least one parameter associated with the determined at least one media source based on the at least one user interface input; and a media source processor configured to control media source processing based on the media source location estimates.

### FIELD

The present application relates to apparatus and methods for distributed audio capture and mixing. The invention further relates to, but is not limited to, apparatus and methods for distributed audio capture and mixing for spatial processing of audio signals to enable spatial reproduction of audio signals.

### BACKGROUND

Capture of audio signals from multiple sources and mixing of those audio signals when these sources are moving in the spatial field requires significant manual effort. For example the capture and mixing of an audio signal source such as a speaker or artist within an audio environment such as a theatre or lecture hall to be presented to a listener and produce an effective audio atmosphere requires significant investment in equipment and training.

A commonly implemented system would be for a professional producer to utilize a close microphone, for example a Lavalier microphone worn by the user or a microphone attached to a boom pole to capture audio signals close to the speaker or other sources, and then manually mix this captured audio signal with one or more suitable spatial (or environmental or audio field) audio signals such that the produced sound comes from an intended direction.

The spatial capture apparatus or omni-directional content capture (OCC) devices should be able to capture high quality audio signal while being able to track the close microphones.

Furthermore control of such systems is complex and requires the user to have a significant knowledge of inputs and output configurations. For example it can be difficult to enable the user to visualise external sound sources and external capture apparatus in a distributed capture system. Furthermore current systems are unable to visualise what type of external capture apparatus they are, how to select different filtering parameters, how to link the external capture apparatus to actual mixer audio channels, and how to associate different locator tags to these external capture apparatus and the associated sources.

Furthermore in current systems there is an inherent problem in that external capture apparatus audio signals are associated with a locator tag. Such tags are typically designed with a validity or expiration time. However the control systems and the user interface controls do not currently handle the expiration of the validity or expiration time. In other words there is currently no methods proposed to determine what to do with respect to tag validity time control nor what to do if the tag validity is expiring or how to handle the external capture apparatus audio stream which fails to produce a signal for a certain time period.

Finally current systems capture audio signal inputs from both spatial audio device microphone arrays and external capture apparatus microphones. Current systems do not provide an easy way to enable the user to discriminate between audio channels which provide an audio input that is to be spatially audio (SPAC) processed before binaural rendering and which only need binaural rendering (external sources). In other words currently there are no definitions which enable SPAC microphone configuration or enable the support for different microphone configurations for operation and support for multiple devices?

### SUMMARY

According to a first aspect there is provided an apparatus comprising: a locator configured to determine at least one media source location; a user interface configured to generate at least one user interface element associated with the at least one media source; the user interface further configured to receive at least one user interface input associated with the user interface element; a media source controller configured to manage control of at least one parameter associated with the determined at least one media source based on the at least one user interface input; and a media source processor configured to control media source processing based on the media source location estimates.

The locator may comprise at least one of: a radio based positioning locator configured to determine a radio based positioning based media source location estimate; a visual locator configured to determine a visual based media source location estimate; and an audio locator configured to determine an audio based media source location estimate.

The user interface may be configured to generate a visual representation identifying the media source located at a position based on the tracked media source location estimate.

The user interface may be configured to generate a source type selection menu to enable an input to identify the at least one media source type wherein the visual representation identifying the media source located at a position based on the tracked media source location estimate may be determined based on a selected item from the source type selection menu.

The user interface may be configured to generate a tracking control selection menu; and inputting at least one media source tracking profile wherein the media source controller may be configured to manage of tracking of media source location estimates is based on the a selected item from the tracking control selection menu.

The user interface may be configured to generate a tag position visual representation enabling the user to define a position on the visual representation for a tag position; and wherein the media source controller may be configured to manage tracking of media source location estimates based on a positional offset defined by the selected position on the visual representation for the tag position.

The user interface may be configured to: generate a mixing desk visual representation comprising a plurality of audio channels; and generate a visual representation linking an audio channel from the mixing desk visual representation to a user interface visual representation associated with the at least one media source.

The user interface may be configured to generate: generate at least one meter visual representation; and associate the at least one meter visual representation with the visual representation associated with the at least one media source.

The user interface may be configured to: highlight any audio channels of the mixing desk visual representation associated with at least one user interface visual representation associated with the at least one media source in a first highlighting effect; and highlight any audio channels of the mixing desk visual representation associated with an output channel in a second highlighting effect.

The user interface may be configured to generate a user interface control enabling the definition of a rendering output format, wherein the media source processor may be configured to control media source processing based on the tracked media source location estimates is further based on the rending output format definition.

The user interface may be configured to generate a user interface control enabling the definition of a spatial processing operation, wherein the media source processor is configured to control media source processing based on the tracked media source location estimates may be further based on the spatial processing definition.

The media source controller may be further configured to: monitor an expiration timer associated with a tag used to provide a radio based positioning based media source location estimate; determine the near expiration/expiration of the expiration timer; determine an expiration time policy; and apply the expiration time policy to the management of tracking of the media source location estimate associated with the tag.

The media source controller configured to manage control of at least one parameter associated with the determined at least one media source based on the at least one user interface input may be further configured to: determine a reinitialize tag policy; determine a reinitialization of the expiration time associated with a tag; apply the reinitialize tag policy to management of tracking of the media source location estimate associated with the tag.

The media source controller may be configured to manage control of at least one parameter associated with the determined at least one media source based on the at least one user interface input in real time.

The apparatus may further comprise a plurality of microphones arranged in a geometry such that the apparatus is configured to capture sound from pre-determined directions around the formed geometry.

The media source may be associated with at least one remote microphone configured to generate at least one remote audio signal from the media source, wherein the apparatus may be configured to receive the remote audio signal.

The media source may be associated with at least one remote microphone configured to generate an remote audio signal from the media source, wherein the apparatus may be configured to transmit the audio source location to a further apparatus, the further apparatus may be configured to receive the remote audio signal.

According to a second aspect there is provided a method comprising: determining at least one media source location; generating at least one user interface element associated with the at least one media source; receiving at least one user interface input associated with the user interface element; managing control of at least one parameter associated with the determined at least one media source based on the at least one user interface input; and controlling media source processing based on the media source location estimates.

Determining at least one media source location may comprise at least one of: determining a radio based positioning based media source location estimate; determining a visual based media source location estimate; and determining an audio based media source location estimate.

Generating at least one user interface element associated with the at least one media source may comprise generating a visual representation identifying the media source located at a position based on the tracked media source location estimate.

Generating at least one user interface element associated with the at least one media source may comprise generating a source type selection menu to enable an input to identify the at least one media source type wherein generating the visual representation identifying the media source located at a position based on the tracked media source location estimate may comprise generating the visual representation based on a selected item from the source type selection menu.

Generating at least one user interface element associated with the at least one media source may comprise generating a tracking control selection menu, receiving at least one user interface input associated with the user interface element may comprise inputting at least one media source tracking profile, and managing control of at least one parameter associated with the determined at least one media source based on the at least one user interface input may comprise managing tracking of media source location estimates based on the a selected item from the tracking control selection menu.

Generating at least one user interface element associated with the at least one media source may comprise generating a tag position visual representation enabling the user to define a position on the visual representation for a tag position; and managing control of at least one parameter associated with the determined at least one media source based on the at least one user interface input may comprise managing tracking of media source location estimates based on a positional offset defined by the selected position on the visual representation for the tag position.

Generating at least one user interface element associated with the at least one media source may comprise: generating a mixing desk visual representation comprising a plurality of audio channels; and generating a visual representation linking an audio channel from the mixing desk visual representation to a user interface visual representation associated with the at least one media source.

Generating at least one user interface element associated with the at least one media source may comprise: generating at least one meter visual representation; and associating the at least one meter visual representation with the visual representation associated with the at least one media source.

Generating at least one user interface element associated with the at least one media source may comprise: highlighting any audio channels of the mixing desk visual representation associated with at least one user interface visual representation associated with the at least one media source in a first highlighting effect; and highlighting any audio channels of the mixing desk visual representation associated with an output channel in a second highlighting effect.

Generating at least one user interface element associated with the at least one media source may comprise generating a user interface control enabling the definition of a rendering output format, wherein controlling media source processing based on the media source location estimates may comprise controlling media source processing based on the rending output format definition.

Generating at least one user interface element associated with the at least one media source may comprise generating a user interface control enabling the definition of a spatial processing operation, wherein controlling media source processing based on the media source location estimates may comprise controlling media source processing based on the spatial processing definition.

Managing control of at least one parameter associated with the determined at least one media source further may comprise: monitoring an expiration timer associated with a tag used to provide a radio based positioning based media source location estimate; determining the near expiration/expiration of the expiration timer; determining an expiration time policy; and applying the expiration time policy to the management of tracking of the media source location estimate associated with the tag.

Managing control of at least one parameter associated with the determined at least one media source may further comprise: determining a reinitialize tag policy; determining a reinitialization of the expiration time associated with a tag; applying the reinitialize tag policy to management of tracking of the media source location estimate associated with the tag.

Managing control of at least one parameter associated with the determined at least one media source further may comprise managing control of at least one parameter associated with the determined at least one media source based on the at least one user interface input in real time.

The method may further comprise: providing a plurality of microphones arranged in a geometry such that the apparatus is configured to capture sound from pre-determined directions around the formed geometry.

The media source may be associated with at least one remote microphone configured to generate at least one remote audio signal from the media source, the method may comprise receiving the remote audio signal.

The media source may be associated with at least one remote microphone configured to generate an remote audio signal from the media source, wherein the method may comprise transmitting the audio source location to a further apparatus, the further apparatus configured to receive the remote audio signal.

According to a third aspect there is provided an apparatus comprising: means for determining at least one media source location; means for generating at least one user interface element associated with the at least one media source; means for receiving at least one user interface input associated with the user interface element; means for managing control of at least one parameter associated with the determined at least one media source based on the at least one user interface input; and means for controlling media source processing based on the media source location estimates.

The means for determining at least one media source location may comprise at least one of: means for determining a radio based positioning based media source location estimate; means for determining a visual based media source location estimate; and means for determining an audio based media source location estimate.

The means for generating at least one user interface element associated with the at least one media source may comprise means for generating a visual representation identifying the media source located at a position based on the tracked media source location estimate.

The means for generating at least one user interface element associated with the at least one media source may comprise means for generating a source type selection menu to enable an input to identify the at least one media source type wherein the means for generating the visual representation identifying the media source located at a position based on the tracked media source location estimate may comprise means for generating the visual representation based on a selected item from the source type selection menu.

The means for generating at least one user interface element associated with the at least one media source may comprise means for generating a tracking control selection menu, means for receiving at least one user interface input associated with the user interface element may comprise inputting at least one media source tracking profile, and means for managing control of at least one parameter associated with the determined at least one media source based on the at least one user interface input may comprise means for managing tracking of media source location estimates based on the a selected item from the tracking control selection menu.

The means for generating at least one user interface element associated with the at least one media source may comprise means for generating a tag position visual representation enabling the user to define a position on the visual representation for a tag position; and means for managing control of at least one parameter associated with the determined at least one media source based on the at least one user interface input may comprise means for managing tracking of media source location estimates based on a positional offset defined by the selected position on the visual representation for the tag position.

The means for generating at least one user interface element associated with the at least one media source may comprise: means for generating a mixing desk visual representation comprising a plurality of audio channels; and means for generating a visual representation linking an audio channel from the mixing desk visual representation to a user interface visual representation associated with the at least one media source.

The means for generating at least one user interface element associated with the at least one media source may comprise: means for generating at least one meter visual representation; and means for associating the at least one meter visual representation with the visual representation associated with the at least one media source.

The means for generating at least one user interface element associated with the at least one media source may comprise: means for highlighting any audio channels of the mixing desk visual representation associated with at least one user interface visual representation associated with the at least one media source in a first highlighting effect; and means for highlighting any audio channels of the mixing desk visual representation associated with an output channel in a second highlighting effect.

The means for generating at least one user interface element associated with the at least one media source may comprise means for generating a user interface control enabling the definition of a rendering output format, wherein the means for controlling media source processing based on the media source location estimates may comprise controlling media source processing based on the rending output format definition.

The means for generating at least one user interface element associated with the at least one media source may comprise means for generating a user interface control enabling the definition of a spatial processing operation, wherein means for controlling media source processing based on the media source location estimates may comprise means for controlling media source processing based on the spatial processing definition.

The means for managing control of at least one parameter associated with the determined at least one media source further may comprise: means for monitoring an expiration timer associated with a tag used to provide a radio based positioning based media source location estimate; means for determining the near expiration/expiration of the expiration timer; means for determining an expiration time policy; and means for applying the expiration time policy to the management of tracking of the media source location estimate associated with the tag.

The means for managing control of at least one parameter associated with the determined at least one media source may further comprise: means for determining a reinitialize tag policy; means for determining a reinitialization of the expiration time associated with a tag; means for applying the reinitialize tag policy to management of tracking of the media source location estimate associated with the tag.

The means for managing control of at least one parameter associated with the determined at least one media source further may comprise means for managing control of at least one parameter associated with the determined at least one media source based on the at least one user interface input in real time.

The apparatus may further comprise: a plurality of microphones arranged in a geometry such that the apparatus is configured to capture sound from pre-determined directions around the formed geometry.

The media source may be associated with at least one remote microphone configured to generate at least one remote audio signal from the media source, the method may comprise means for receiving the remote audio signal.

The media source may be associated with at least one remote microphone configured to generate an remote audio signal from the media source, wherein the apparatus may comprise means for transmitting the audio source location to a further apparatus, the further apparatus configured to receive the remote audio signal.

A computer program product stored on a medium may cause an apparatus to perform the method as described herein.

An electronic device may comprise apparatus as described herein.

A chipset may comprise apparatus as described herein.

Embodiments of the present application aim to address problems associated with the state of the art.

### SUMMARY OF THE FIGURES

For a better understanding of the present application, reference will now be made by way of example to the accompanying drawings in which:

FIG. 1 shows schematically example track management, fusion and media handling system which may implement some embodiments;

FIGS. 2a to 2d show example user interface visualisations for representing the external capture apparatus and OCC apparatus according to some embodiments;

FIGS. 3 and 4 show example user interface visualisations for representing the external capture apparatus and OCC apparatus and mapped audio mixer controls according to some embodiments;

FIG. 5 shows an example user interface visualisation with mapped audio mixer controls highlighted according to whether the audio signal is to be spatial audio processed according to some embodiments;

FIG. 6 shows example user interface visualisation for representing manual positioning of audio sources according to some embodiments;

FIG. 7 shows a further example user interface visualisation for representing manual positioning of audio sources in three dimensions according to some embodiments;

FIG. 8 shows a flow diagram of an example tag expiration handing operation;

FIG. 9 shows schematically capture and render apparatus suitable for implementing spatial audio capture and rendering according to some embodiments; and

FIG. 10 shows schematically an example device suitable for implementing the capture and/or render apparatus shown in FIG. 9.

### EMBODIMENTS OF THE APPLICATION

The following describes in further detail suitable apparatus and possible mechanisms for the provision of effective capture of audio signals from multiple sources and mixing of those audio signals. In the following examples, audio signals and audio capture signals are described. However it would be appreciated that in some embodiments the apparatus may be part of any suitable electronic device or apparatus configured to capture an audio signal or receive the audio signals and other information signals.

As described previously a conventional approach to the capturing and mixing of audio sources with respect to an audio background or environment audio field signal would be for a professional producer to utilize an external or close microphone (for example a Lavalier microphone worn by the user or a microphone attached to a boom pole) to capture audio signals close to the audio source, and further utilize a omnidirectional object capture microphone to capture an environmental audio signal. These signals or audio tracks may then be manually mixed to produce an output audio signal such that the produced sound features the audio source coming from an intended (though not necessarily the original) direction.

As would be expected this requires significant time and effort and expertise to do correctly. Furthermore in order to cover a large venue, multiple points of omni-directional capture are needed to create a holistic coverage of the event.

The concept as described herein is embodied in a controller and suitable user interface which may makes it possible to capture and remix an external or close audio signal and spatial or environmental audio signal more effectively and efficiently.

Thus for example in some embodiments there is provided a user interface (UI) that allows or enables the selection of determined location (radio based positioning, for example indoor positioning such as HAIP) tags and further enables either automatically, semi-automatically or manually a visual identifier or representation of the source to be added in order to identify a source. For example the representation may identify the source or external capture apparatus as being associated with a person, a guitar or other instrument etc. In some embodiments furthermore the UI allows or enables a preset filter or processing to be applied in order to easily provide a better performance audio output. For example the presets may be identified as “sports”, “concert”, “reporter” and can be associated with the audio sources within the UI. The selected preset may further control how the locator and the location tracker attempts to track the tags or sources. For example the locator and the location tracker may be controlled in terms of tag sampling delay, averaging the tag or location signal, allowing fast (or only slow) tracking movements. Furthermore in some embodiments the UI may in provide a visual representation of a mixing desk and furthermore visualises a link between the visual representation of the sources to the representation of the mixing desk audio channels. In some embodiments the UI further provides and indicates the link with a representation of a VU meter to the representation of the mixer tracks.

Thus in some embodiments a live rock concert may implement such embodiment and enable a user to make quick changes to the mix. In this case it is relevant to visually link the possible moving sound sources to the mixing desk in an intuitive way. In a further music case in order to receive an immersive audio experience, the sound changes representing movement in the spatial audio feed should be smooth and thus enable the UI to select where no fast movements should be allowed, even potentially with the expense of accuracy.

Although the following example are described with respect to music source location it us understood that the concept may be applied to other locator based embodiments. For example a locator tag may be placed inside a golf ball to render a trajectory of a golf shot. However the location tracking filtering in such embodiments needs to be set to a fast tracking and thus be configured to receive as many raw packets as possible without any initial smoothing of additional processing of the signal. In such embodiments post-processing can be applied to smoothen the trajectory.

Typically the locator (radio based positioning for example indoor positioning such as HAIP or similar) tags is configured to expire after a certain amount of time. This time can be extended by pressing a physical button on the tag. However some embodiments as described in further detail may be configured to overcome the problem associated with an expiring tag during a performance or signal not being received temperately for some reason (blockage etc.). In such embodiments the locator or locator tracker may be configured to monitor the expiration time (or read the time wirelessly from the tag). In such embodiments when the tag runs out, the controller may be configured to control the audio mixing and rendering to fade out the audio before the location accuracy is lost. Alternatively or in addition to, the audio may be positioned to a specific location such as the front center when the location accuracy is lost, where the location is selected such that it would result in an aesthetically pleasing sound scene for various sound source positions. In some embodiments the locator tracker may be configured to apply audio beamforming techniques on the audio from spatial audio capture apparatus (the OCC) to focus on the last known position or direct a camera to that position and to attempt to try to use audio based and/or visual tracking of the object. In some embodiments the controller may signal to the external capture apparatus to notify the performer to re-initiate the locator tag and reset the expiry time.

Furthermore regardless of the tag type, there is a need to save power and thus not keep the tag operational at all times. The embodiments and methods as described herein can be applied also to any type of tags where the expiry time can be known, and there is the need to cope from unexpected situations where the expiry time cannot be estimated or comes as a surprise.

In some embodiments a similar expiry time or time out method may be applied to any suitable content analysis based tracking (e.g. with visual analysis). The visual analysis based position tracking can thus provide robust results in certain designated illumination conditions. Consequently, the visual analysis robustness may be monitored on a continuing basis and when it appears to have a confidence measure of less than a threshold value, the source location can be fixed or made static in order to avoid error movements being represented in the external sound source.

Thus for example in a music performance, a player wearing a close-up microphone and a localization tag may not transmit the location any more. With a music performance, it is important that the estimated location does not change quickly and thus the audio may be rendered to the last known position until an alternative tracking system (if available) will be able to track the source and interpolate the position smoothly to the new correct position. However when the tag suddenly come alive and transmits data, the position may be recovered smoothly as well. Alternatively to rendering the audio in the last known position, the source may be moved to a predefined other position such as the front center during the time when the tracking is lost. When the tracking is restored, the source may again be moved to its actual location is a gradual manner. In some embodiments, the system will, after the restoring of the location tracking, wait until the source is sufficiently close to the position during lost tracking, and only then move the source to its actual location. For example, if a source is at the front center during lost position tracking, the system may wait until the source is sufficiently close to the front center position after restored location tracking, and then gradually move the location from the front center position to the actual position and start updating the position dynamically.

In another example the capturing or streaming of an election debate where each person has 5 minutes time to state their answer to a defined question. In such embodiments the tag may start to blink once a predetermined time period remaining is reached (for example there is only 30 seconds time left) and finally the audio is faded out once the localization time ends. In some embodiments the participant may request for a new time slot by pressing the button from the tag. If granted, the tag may then flash.

In some embodiments the concept may be embodied by a user interface being able to support different OCC (spatial capture devices) and external capture apparatus configurations. In some embodiments therefore there is provided a UI which enables the selection of channels which are raw microphone inputs in other words requiring spatial processing (SPAC) and binaural rendering. Similarly the UI may be configured to enable the selection of channels which only need binaural rendering.

In such embodiments the audio signals or channels that require SPAC, the UI may further provide a visual representation enabling the definition of the relative microphone positions and directions to drive the SPAC processing operations. In some embodiments the UI may enable the renderer to render the audio signals to a defined format, e.g, 4.0, 5.1, 7.1 and pass these to the binaural renderer. In some embodiments the UI enables the manual positioning of output locations in the selected formats.

Thus for example using a distributed capture system with a new set of audio equipment from a venue. The channels can be easily mapped with the proposed UI.

Furthermore in some examples the UI controls an audio mixer with a new or un-configured OCC (new spatial audio capture device). The OCC may thus be configured for optimal SPAC analysis using such a UI.

The concept may for example be embodied as a capture system configured to capture both an external or close (speaker, instrument or other source) audio signal and a spatial (audio field) audio signal.

The concept furthermore is embodied by a presence capture or an omni-directional content capture (OCC) apparatus or device.

Although the capture and render systems in the following examples are shown as being separate, it is understood that they may be implemented with the same apparatus or may be distributed over a series of physically separate but communication capable apparatus. For example, a presence-capturing device such as the Nokia OZO device could be equipped with an additional interface for analysing external microphone sources, and could be configured to perform the capture part. The output of the capture part could be a spatial audio capture format (e.g. as a 5.1 channel downmix), the Lavalier sources which are time-delay compensated to match the time of the spatial audio, and other information such as the classification of the source and the space within which the source is found.

In some embodiments the raw spatial audio captured by the array microphones (instead of spatial audio processed into 5.1) may be transmitted to the mixer and renderer and the mixer/renderer perform spatial processing on these signals.

The playback apparatus as described herein may be a set of headphones with a motion tracker, and software capable of presenting binaural audio rendering. With head tracking, the spatial audio can be rendered in a fixed orientation with regards to the earth, instead of rotating along with the person's head.

Alternatively, the playback apparatus may utilize a set of loudspeakers, for example, in a 5.1 or 7.1 configuration for the audio playback.

Furthermore it is understood that at least some elements of the following capture and render apparatus may be implemented within a distributed computing system such as known as the ‘cloud’.

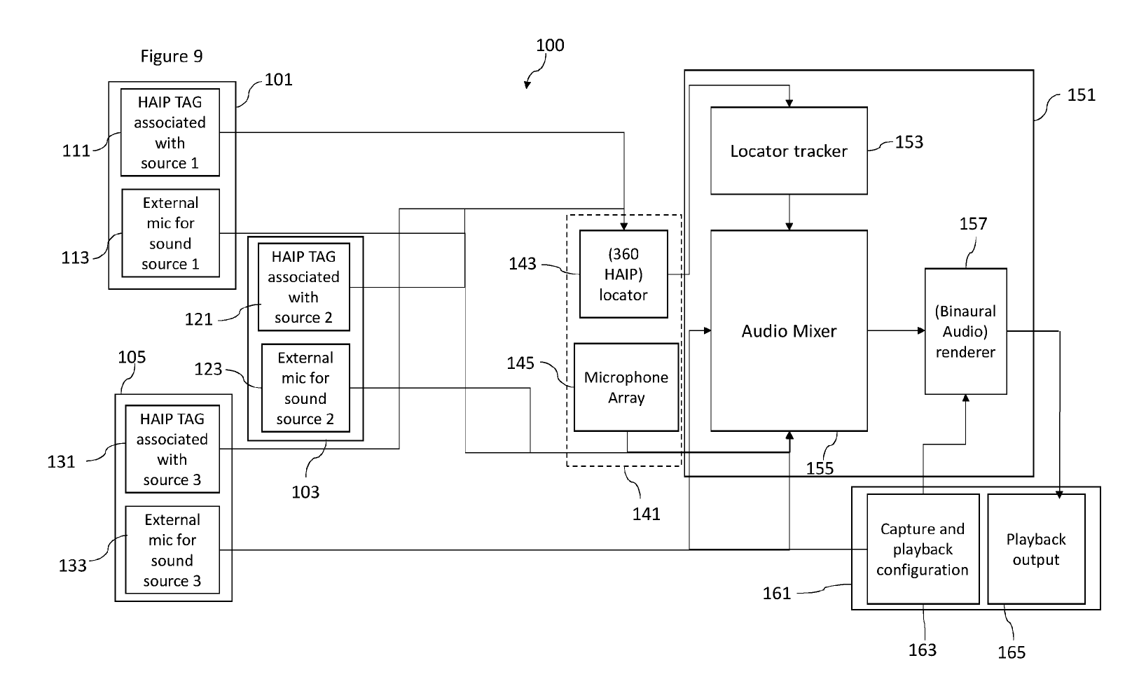

With respect to FIG. 9 is shown a system comprising local capture apparatus 101, 103 and 105, a single omni-directional content capture (OCC) apparatus 141, mixer/render 151 apparatus, and content playback 161 apparatus suitable for implementing audio capture, rendering and playback according to some embodiments.

In this example there is shown only three local capture apparatus 101, 103 and 105 configured to generate three local audio signals, however more than or fewer than 3 local capture apparatus may be employed.

The first local capture apparatus 101 may comprise a first external (or Lavalier) microphone 113 for sound source 1. The external microphone is an example of a ‘close’ audio source capture apparatus and may in some embodiments be a boom microphone or similar neighbouring microphone capture system.

Although the following examples are described with respect to an external microphone as a Lavalier microphone the concept may be extended to any microphone external or separate to the omni-directional content capture (OCC) apparatus. Thus the external microphones may be Lavalier microphones, hand held microphones, mounted mics, or whatever. The external microphones can be worn/carried by persons or mounted as close-up microphones for instruments or a microphone in some relevant location which the designer wishes to capture accurately. The external microphone 113 may in some embodiments be a microphone array.

A Lavalier microphone typically comprises a small microphone worn around the ear or otherwise close to the mouth. For other sound sources, such as musical instruments, the audio signal may be provided either by a Lavalier microphone or by an internal microphone system of the instrument (e.g., pick-up microphones in the case of an electric guitar).

The external microphone 113 may be configured to output the captured audio signals to an audio mixer and renderer 151 (and in some embodiments the audio mixer 155). The external microphone 113 may be connected to a transmitter unit (not shown), which wirelessly transmits the audio signal to a receiver unit (not shown).

Furthermore the first local capture apparatus 101 comprises a position tag 111. The position tag 111 may be configured to provide information identifying the position or location of the first capture apparatus 101 and the external microphone 113.

It is important to note that microphones worn by people can freely move in the acoustic space and the system supporting location sensing of wearable microphone has to support continuous sensing of user or microphone location. The position tag 111 may thus be configured to output the tag signal to a position locator 143.

In the example as shown in FIG. 9, a second local capture apparatus 103 comprises a second external microphone 123 for sound source 2 and furthermore a position tag 121 for identifying the position or location of the second local capture apparatus 103 and the second external microphone 123.

Furthermore a third local capture apparatus 105 comprises a third external microphone 133 for sound source 3 and furthermore a position tag 131 for identifying the position or location of the third local capture apparatus 105 and the third external microphone 133.

In the following examples the positioning system and the tag may employ High Accuracy Indoor Positioning (HAIP) or another suitable indoor positioning technology. In the HAIP technology, as developed by Nokia, Bluetooth Low Energy is utilized. The positioning technology may also be based on other radio systems, such as WiFi, or some proprietary technology. The indoor positioning system in the examples is based on direction of arrival estimation where antenna arrays are being utilized in 143. There can be various realizations of the positioning system and an example of which is the radio based location or positioning system described here. The location or positioning system may in some embodiments be configured to output a location (for example, but not restricted, in azimuth plane, or azimuth domain) and distance based location estimate.

For example, GPS is a radio based system where the time-of-flight may be determined very accurately. This, to some extent, can be reproduced in indoor environments using WiFi signaling.

The described system however may provide angular information directly, which in turn can be used very conveniently in the audio solution.

In some example embodiments the location can be determined or the location by the tag can be assisted by using the output signals of the plurality of microphones and/or plurality of cameras.

Although the following examples describe radio based positioning or locating it is understood that this may be implemented in external locations. For example such apparatus and methods described herein may be used in open top places such as stadiums, concerts, substantially enclosed venues/places, semi indoor, semi-outdoor locations etc.

The capture apparatus 101 comprises an omni-directional content capture (OCC) apparatus 141. The omni-directional content capture (OCC) apparatus 141 is an example of an ‘audio field’ capture apparatus. In some embodiments the omni-directional content capture (OCC) apparatus 141 may comprise a directional or omnidirectional microphone array 145. The omni-directional content capture (OCC) apparatus 141 may be configured to output the captured audio signals to the mixer/render apparatus 151 (and in some embodiments an audio mixer 155).

Furthermore the omni-directional content capture (OCC) apparatus 141 comprises a source locator 143. The source locator 143 may be configured to receive the information from the position tags 111, 121, 131 associated with the audio sources and identify the position or location of the local capture apparatus 101, 103, and 105 relative to the omni-directional content capture apparatus 141. The source locator 143 may be configured to output this determination of the position of the spatial capture microphone to the mixer/render apparatus 151 (and in some embodiments a position tracker or position server 153). In some embodiments as discussed herein the source locator receives information from the positioning tags within or associated with the external capture apparatus. In addition to these positioning tag signals, the source locator may use video content analysis and/or sound source localization to assist in the identification of the source locations relative to the OCC apparatus 141.

As shown in further detail, the source locator 143 and the microphone array 145 are co-axially located. In other words the relative position and orientation of the source locator 143 and the microphone array 145 is known and defined.

In some embodiments the source locator 143 is position determiner. The position determiner is configured to receive the indoor positioning locator tags from the external capture apparatus and furthermore determine the location and/or orientation of the OCC apparatus 141 in order to be able to determine an position or location from the tag information. This for example may be used where there are multiple OCC apparatus 141 and thus external sources may be defined with respect to an absolute co-ordinate system. In the following examples the positioning system and the tag may employ High Accuracy Indoor Positioning (HAIP) or another suitable indoor positioning technology and thus are HAIP tags. In the HAIP technology, as developed By Nokia, Bluetooth Low Energy is utilized. The positioning technology may also be based on other radio systems, such as WiFi, or some proprietary technology. The positioning system in the examples is based on direction of arrival estimation where antenna arrays are being utilized.

In some embodiments the omni-directional content capture (OCC) apparatus 141 may implement at least some of the functionality within a mobile device.

The omni-directional content capture (OCC) apparatus 141 is thus configured to capture spatial audio, which, when rendered to a listener, enables the listener to experience the sound field as if they were present in the location of the spatial audio capture device.

The local capture apparatus comprising the external microphone in such embodiments is configured to capture high quality close-up audio signals (for example from a key person's voice, or a musical instrument).

The mixer/render apparatus 151 may comprise a position tracker (or position server) 153. The position tracker 153 may be configured to receive the relative positions from the omni-directional content capture (OCC) apparatus 141 (and in some embodiments the source locator 143) and be configured to output parameters to an audio mixer 155.

Thus in some embodiments the position or location of the OCC apparatus is determined. The location of the spatial audio capture device may be denoted (at time 0) as

(x_{S}(0),y_{S}(0))

In some embodiments there may be implemented a calibration phase or operation (in other words defining a 0 time instance) where one or more of the external capture apparatus are positioned in front of the microphone array at some distance within the range of a positioning locator. This position of the external capture (Lavalier) microphone may be denoted as

(x_{L}(0),y_{L}(0))

Furthermore in some embodiments this calibration phase can determine the ‘front-direction’ of the spatial audio capture device in the positioning coordinate system. This can be performed by firstly defining the array front direction by the vector

(x_{L}(0)−x_{S}(0),y_{L}(0)−y_{S}(0))

This vector may enable the position tracker to determine an azimuth angle α and the distance d with respect to the OCC and the microphone array.

For example given an external (Lavalier) microphone position at time t

(x_{L}(t),y_{L}(t))

The direction relative to the array is defined by the vector

(x_{L}(t)−x_{S}(0),y_{L}(t)−y_{S}(0))

The azimuth α may then be determined as

α=a tan 2(y_{L}(t)−y_{S}(0),x_{L}(t)−x_{S}(0))−a tan 2(y_{L}(0)−y_{S}(0),x_{L}(0)−x_{S}(0))

where a tan 2(y,x) is a “Four-Quadrant Inverse Tangent” which gives the angle between the positive x-axis and the point (x,y). Thus, the first term gives the angle between the positive x-axis (origin at x_{S}(0) and y_{S}(0)) and the point (x_{L}(t), y_{L}(t)) and the second term is the angle between the x-axis and the initial position (x_{L}(0),y_{L}(0)). The azimuth angle may be obtained by subtracting the first angle from the second.

The distance d can be obtained as

{square root over ((x_{L}(t)−x_{S}(0))²+(y(t)−y_{S}(0))²)}

In some embodiments, since the positioning location data may be noisy, the positions (x_{L}(0), y_{L}(0) and (x_{S}(0), y_{S}(0)) may be obtained by recording the positions of the positioning tags of the audio capture device and the external (Lavalier) microphone over a time window of some seconds (for example 30 seconds) and then averaging the recorded positions to obtain the inputs used in the equations above.

In some embodiments the calibration phase may be initialized by the OCC apparatus being configured to output a speech or other instruction to instruct the user(s) to stay in front of the array for the 30 second duration, and give a sound indication after the period has ended.

Although the examples shown above show the locator 145 generating location or position information in two dimensions it is understood that this may be generalized to three dimensions, where the position tracker may determine an elevation angle or elevation offset as well as an azimuth angle and distance.

In some embodiments other position locating or tracking means can be used for locating and tracking the moving sources. Examples of other tracking means may include inertial sensors, radar, ultrasound sensing, Lidar or laser distance meters, and so on.

In some embodiments, visual analysis and/or audio source localization are used to assist positioning.

Visual analysis, for example, may be performed in order to localize and track predefined sound sources, such as persons and musical instruments. The visual analysis may be applied on panoramic video which is captured along with the spatial audio. This analysis may thus identify and track the position of persons carrying the external microphones based on visual identification of the person. The advantage of visual tracking is that it may be used even when the sound source is silent and therefore when it is difficult to rely on audio based tracking. The visual tracking can be based on executing or running detectors trained on suitable datasets (such as datasets of images containing pedestrians) for each panoramic video frame. In some other embodiments tracking techniques such as kalman filtering and particle filtering can be implemented to obtain the correct trajectory of persons through video frames. The location of the person with respect to the front direction of the panoramic video, coinciding with the front direction of the spatial audio capture device, can then be used as the direction of arrival for that source. In some embodiments, visual markers or detectors based on the appearance of the Lavalier microphones could be used to help or improve the accuracy of the visual tracking methods.

In some embodiments visual analysis can not only provide information about the 2D position of the sound source (i.e., coordinates within the panoramic video frame), but can also provide information about the distance, which is proportional to the size of the detected sound source, assuming that a “standard” size for that sound source class is known. For example, the distance of ‘any’ person can be estimated based on an average height. Alternatively, a more precise distance estimate can be achieved by assuming that the system knows the size of the specific sound source. For example the system may know or be trained with the height of each person who needs to be tracked.

In some embodiments the 3D or distance information may be achieved by using depth-sensing devices. For example a ‘Kinect’ system, a time of flight camera, stereo cameras, or camera arrays, can be used to generate images which may be analyzed and from image disparity from multiple images a depth may or 3D visual scene may be created. These images may be generated by a camera.

Audio source position determination and tracking can in some embodiments be used to track the sources. The source direction can be estimated, for example, using a time difference of arrival (TDOA) method. The source position determination may in some embodiments be implemented using steered beamformers along with particle filter-based tracking algorithms.

In some embodiments audio self-localization can be used to track the sources.

There are technologies, in radio technologies and connectivity solutions, which can furthermore support high accuracy synchronization between devices which can simplify distance measurement by removing the time offset uncertainty in audio correlation analysis. These techniques have been proposed for future WiFi standardization for the multichannel audio playback systems.

In some embodiments, position estimates from positioning, visual analysis, and audio source localization can be used together, for example, the estimates provided by each may be averaged to obtain improved position determination and tracking accuracy. Furthermore, in order to minimize the computational load of visual analysis (which is typically much “heavier” than the analysis of audio or positioning signals), visual analysis may be applied only on portions of the entire panoramic frame, which correspond to the spatial locations where the audio and/or positioning analysis sub-systems have estimated the presence of sound sources.

Location or position estimation can, in some embodiments, combine information from multiple sources and combination of multiple estimates has the potential for providing the most accurate position information for the proposed systems. However, it is beneficial that the system can be configured to use a subset of position sensing technologies to produce position estimates even at lower resolution.

The mixer/render apparatus 151 may furthermore comprise an audio mixer 155. The audio mixer 155 may be configured to receive the audio signals from the external microphones 113, 123, and 133 and the omni-directional content capture (OCC) apparatus 141 microphone array 145 and mix these audio signals based on the parameters (spatial and otherwise) from the position tracker 153. The audio mixer 155 may therefore be configured to adjust the gain, spatial position, spectrum, or other parameters associated with each audio signal in order to provide the listener with a much more realistic immersive experience. In addition, it is possible to produce more point-like auditory objects, thus increasing the engagement, intelligibility, or ability to localize the sources. The audio mixer 155 may furthermore receive additional inputs from the playback device 161 (and in some embodiments the capture and playback configuration controller 163) which can modify the mixing of the audio signals from the sources.

The audio mixer in some embodiments may comprise a variable delay compensator configured to receive the outputs of the external microphones and the OCC microphone array. The variable delay compensator may be configured to receive the position estimates and determine any potential timing mismatch or lack of synchronisation between the OCC microphone array audio signals and the external microphone audio signals and determine the timing delay which would be required to restore synchronisation between the signals. In some embodiments the variable delay compensator may be configured to apply the delay to one of the signals before outputting the signals to the renderer 157.

The timing delay may be referred as being a positive time delay or a negative time delay with respect to an audio signal. For example, denote a first (OCC) audio signal by x, and another (external capture apparatus) audio signal by y. The variable delay compensator is configured to try to find a delay T, such that x(n)=y(n−τ). Here, the delay τ can be either positive or negative.

The variable delay compensator may in some embodiments comprises a time delay estimator. The time delay estimator may be configured to receive at least part of the OCC audio signal (for example a central channel of a 5.1 channel format spatial encoded channel). Furthermore the time delay estimator is configured to receive an output from the external capture apparatus microphone 113, 123, 133. Furthermore in some embodiments the time delay estimator can be configured to receive an input from the location tracker 153.

As the external microphone may change its location (for example because the person wearing the microphone moves while speaking), the OCC locator 145 can be configured to track the location or position of the external microphone (relative to the OCC apparatus) over time. Furthermore, the time-varying location of the external microphone relative to the OCC apparatus causes a time-varying delay between the audio signals.

In some embodiments a position or location difference estimate from the location tracker 143 can be used as the initial delay estimate. More specifically, if the distance of the external capture apparatus from the OCC apparatus is d, then an initial delay estimate can be calculated. Any audio correlation used in determining the delay estimate may be calculated such that the correlation centre corresponds with the initial delay value.

In some embodiments the mixer comprises a variable delay line. The variable delay line may be configured to receive the audio signal from the external microphones and delay the audio signal by the delay value estimated by the time delay estimator. In other words when the ‘optimal’ delay is known, the signal captured by the external (Lavalier) microphone is delayed by the corresponding amount.

In some embodiments the mixer/render apparatus 151 may furthermore comprise a renderer 157. In the example shown in FIG. 9 the renderer is a binaural audio renderer configured to receive the output of the mixed audio signals and generate rendered audio signals suitable to be output to the playback apparatus 161. For example in some embodiments the audio mixer 155 is configured to output the mixed audio signals in a first multichannel (such as 5.1 channel or 7.1 channel format) and the renderer 157 renders the multichannel audio signal format into a binaural audio formal. The renderer 157 may be configured to receive an input from the playback apparatus 161 (and in some embodiments the capture and playback configuration controller 163) which defines the output format for the playback apparatus 161. The renderer 157 may then be configured to output the renderer audio signals to the playback apparatus 161 (and in some embodiments the playback output 165).

The audio renderer 157 may thus be configured to receive the mixed or processed audio signals to generate an audio signal which can for example be passed to headphones or other suitable playback output apparatus. However the output mixed audio signal can be passed to any other suitable audio system for playback (for example a 5.1 channel audio amplifier).

In some embodiments the audio renderer 157 may be configured to perform spatial audio processing on the audio signals.

The mixing and rendering may be described initially with respect to a single (mono) channel, which can be one of the multichannel signals from the OCC apparatus or one of the external microphones. Each channel in the multichannel signal set may be processed in a similar manner, with the treatment for external microphone audio signals and OCC apparatus multichannel signals having the following differences:

1) The external microphone audio signals have time-varying location data (direction of arrival and distance) whereas the OCC signals are rendered from a fixed location.

2) The ratio between synthesized “direct” and “ambient” components may be used to control the distance perception for external microphone sources, whereas the OCC signals are rendered with a fixed ratio.

3) The gain of external microphone signals may be adjusted by the user whereas the gain for OCC signals is kept constant.

The playback apparatus 161 in some embodiments comprises a capture and playback configuration controller 163. The capture and playback configuration controller 163 may enable a user of the playback apparatus to personalise the audio experience generated by the mixer 155 and renderer 157 and furthermore enable the mixer/renderer 151 to generate an audio signal in a native format for the playback apparatus 161. The capture and playback configuration controller 163 may thus output control and configuration parameters to the mixer/renderer 151.

The playback apparatus 161 may furthermore comprise a suitable playback output 165.

In such embodiments the OCC apparatus or spatial audio capture apparatus comprises a microphone array positioned in such a way that allows omnidirectional audio scene capture.

Furthermore the multiple external audio sources may provide uncompromised audio capture quality for sound sources of interest.

As described previously one problem associated with the distributed capture system is that with the control and visualisation of tracking of the external capture apparatus or audio sources.

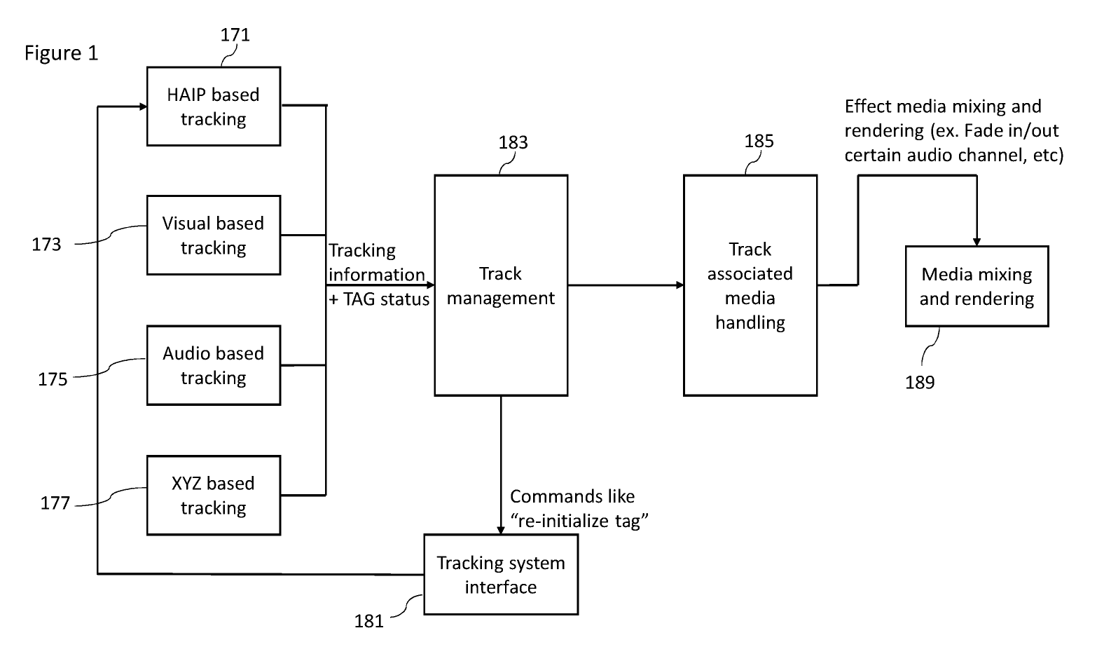

FIG. 1 shows an example location tracking system suitable for implementing with a distributed audio capture system such as shown with respect to FIG. 1.

The tracking system comprises a series of tracking inputs. For example the tracking system may comprise a radio(such as high accuracy indoor positioning—HAIP) based tracker 171. The positioning based tracker 171 may in some embodiments be implemented as part of the OCC and be configured to determine an estimated location of a positioning tag implemented as part of an external capture apparatus (or associated with an external capture apparatus and thus an external audio source). These estimates may be passed to a tracking manager 183.

The tracking system may further comprise a visual based tracker 173. The visual based tracker 173 may in some embodiments be implemented as part of the OCC and be configured to determine an estimated location of an external capture apparatus from analysing at least one image from a camera (for example a camera employed by the OCC). These estimates may be passed to the tracking manager 183.

Furthermore the tracking system may further comprise an audio based tracker 175. The audio based tracker 175 may in some embodiments be implemented as part of the OCC and be configured to determine an estimated location of an external capture apparatus from analysing the audio signals from a microphone array (for example the microphone array employed by the OCC). Such audio-based source localization may be based on, for example, time difference of arrival techniques. These estimates may be passed to the tracking manager 183.

As shown in FIG. 1 the tracking system may further comprise any other suitable tracker (XYZ based tracker 177). The XYZ based tracker 177 may in some embodiments be implemented as part of the OCC and be configured to determine an estimated location of an external capture apparatus. These estimates may be also passed to the tracking manager 183.

The tracking manager 183 may be configured to receive the location or position estimate information from the trackers 171, 173, 175 and 177 and process the information (and in some embodiments the location tag status) in order to track the position of the sources. The tracking manager 183 is an example of a media source controller which is configured to manage control of at least one parameter associated with the determined at least one media source based on at least one user interface input. The tracking manager may in some embodiments be implemented as part of the tracker server as described herein. In some embodiments the tracking manager 183 is configured to generate improved location estimate by combining or averaging the location estimates from the trackers. This combination may for example include low pass filtering the location estimate values for a tracker to reduce location estimation errors. The tracking manager 183 may furthermore control how the tracking of the location estimate is to be performed.

The tracking manager 183 may be configured to output the tracked location estimates to a track associated media handler 185.

The track associated media handler 185 may be configured to determine which types of processing are to be applied (for example the rule sets for processing) to the audio signals from the external capture apparatus. These rule sets may then be passed to the media mixer and renderer 189.

The media mixer and renderer 189 may then apply the tracking based processing to the audio signals from the external capture apparatus. The media mixer and renderer is an example of a media source processor configured to control media source processing based on the media source location estimates.

In some embodiments the tracking system further comprises a tracking system interface 181. The tracking system interface 181 may in some embodiments be configured to receive the tracking information (and the tag status information) from the tracking manager 183 and generate and display suitable visual (or audio) representations of the tracking system to the user. Furthermore in some embodiments the tracking system interface 181 may be configured to receive user interface inputs associated with the UI elements displayed and use these inputs to control the trackers and the tracking management 183. The tracking system interface 181 may be considered to be an example of a user interface configured to generate at least one user interface element associated with the at least one media source. Furthermore the tracking system interface 181 may be considered to be an example of a user interface further configured to receive at least one user interface input associated with the user interface element. The user interface may such as described herein be a graphical user interface but in some embodiments an indication may be provided by other means such as RF signal or an audio signal. For example in the following examples where the positioning tag expires the user interface may be an audio signal or light output to indicate the tag time is about to expire.

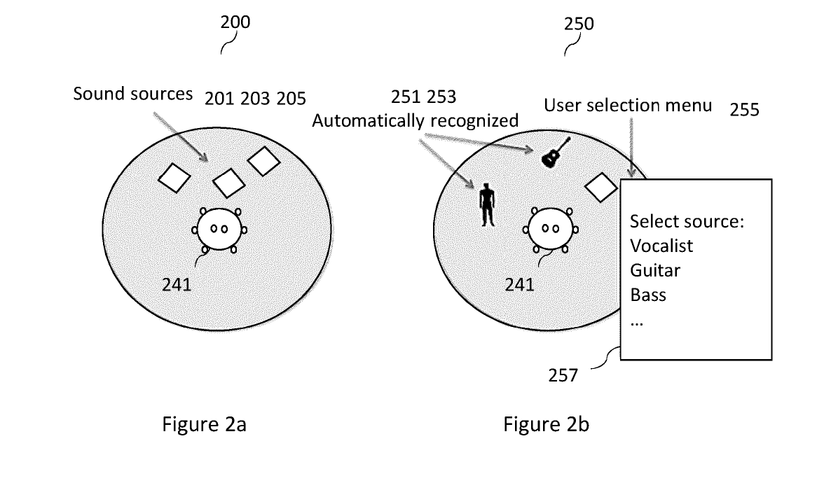

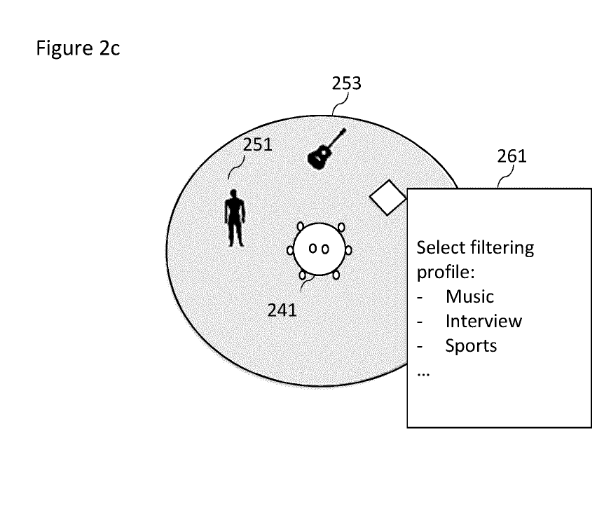

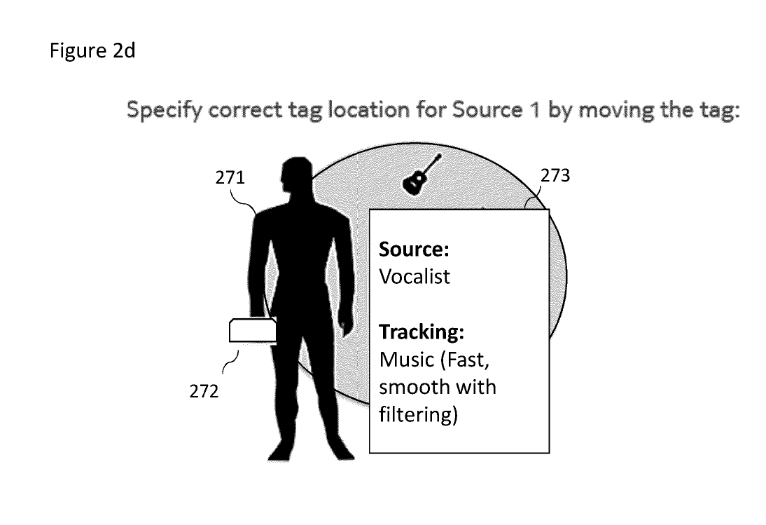

With respect to FIG. 2a an example of a user interface visualisation representing the external capture apparatus or sound sources and an OCC apparatus according to some embodiments is shown. In this example the UI visualisation shows a visual representation of an OCC 241 and within a location range (shown by the range circle) is shown the location of any identified sound sources 201, 203 and 205. The location of the identified sound sources is shown by a simple diamond visual representation at azimuth and range location from the OCC representation 241.

With respect to FIG. 2b a further example of a user interface visualisation representing the external capture apparatus or sound sources and an OCC apparatus according to some embodiments is shown. In this example the UI visualisation shows a visual representation of the OCC 241 and within a location range (shown by the range circle) is shown the location of any identified sound sources. In this example two of the sound sources are automatically recognised and a suitable visual representation 251, 253 replacing the diamond representations 201, 203 are shown. The automatic recognition may be performed by audio, visual analysis or in some embodiments is signalled by a location tag identifier. Furthermore as shown in FIG. 2b, in some embodiments the UI is configured to generate a user selection menu 255 wherein the user may manually identify the source. The user selection menu 255 may for example comprise a list 257 of source types. Having selected a source type in some embodiments the UI is configured to replace the diamond representation with a suitable source type visual representation.

With respect to FIG. 2c a further example of a user interface visualisation representing the external capture apparatus or sound sources and an OCC apparatus according to some embodiments is shown. In this example the UI visualisation shows a visual representation of the OCC 241 and within a location range (shown by the range circle) is shown the location of any identified sound sources. In this example two of the sound sources are automatically recognised and a suitable visual representation 251, 253 replacing the diamond representations 201, 203 are shown. In some embodiments the identification of the source furthermore enables an automatic selection and definition of the tracking filtering of the source location estimate. In some embodiments the UI is further configured to generate a filtering profile menu 261 wherein the user may manually identify and define the tracking filtering of the location estimates associated with the source. The user selection menu 261 may for example comprise a list of filtering profile types. Having selected a filtering profile type (for example music, interview, sports etc) in some embodiments the UI is configured to replace the diamond representation with a suitable profile type visual representation. The selected profile may generate parameters which may be passed to the tracking manger to control the tracking of the sources in terms of tracking update delay, averaging the location estimates and defining whether the source has a maximum or minimum speed (in other words enabling only fast or only slow movements of the location estimate over time).

For example in some embodiments the locator system uses filtering of the positioning signal to determine accurate location information. However the location estimate requirements may be different for different use cases and the system should enable a selection of appropriate filtering methods and/or even be able to manually tune advanced settings.

The filtering profile type may thus control the filtering of the location estimates by changing one or more of the following:
filter length (longer, slower manual)
extreme value removal
average/median selection
allow packet drop
raw data output
smooth transition
allow/disallow threshold of movements
select from a set of predefined motion models for filter parameters, where the motion models could comprise walking/running/dancing/aerobics or the like.

With respect to FIG. 2d a further example of a user interface visualisation representing the external capture apparatus or sound sources and an OCC apparatus according to some embodiments is shown. In this example in order to be able to fine-tune the elevation & azimuth tracking properties for a source the user interface is able to display a large visual representation of the external capture apparatus or person wearing the external capture apparatus and furthermore the approximate location of the locator tag with respect to the external capture apparatus. For example FIG. 2d shows the large ‘vocalist’ source visual representation 271 and tag representation 272 being held by the large ‘vocalist’ source visual representation. FIG. 2d furthermore shows an information summary 273 window showing the source type and the tracking filter type information. The user may place the tag on the recognized (or assigned) object at a position (head, hands, shoulders etc.) to enable any offsets to be defined and improve the tracking function.

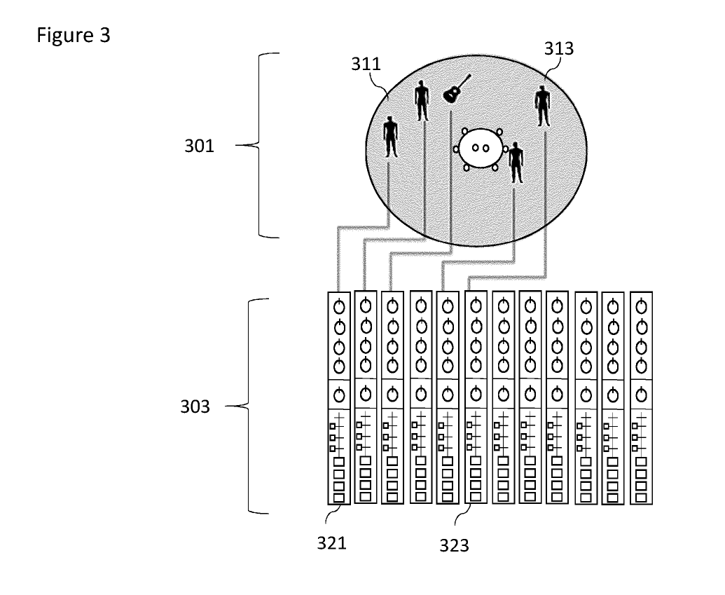

With respect to FIG. 3 a further example of a user interface visualisation representing the external capture apparatus or sound sources and an OCC apparatus according to some embodiments is shown. In this example the visualisation may be formed from a tracking part 301 showing the tracked location estimates for the identified audio sources. For example several visual representations are shown of which a first vocalist visual representation 311 and a second vocalist visual representation 313 are labelled.

Furthermore the user interface shows a mixing desk control part 303 comprising a series of control interfaces each of which may be associated by a visual representation link between the source visual representation and one of the mixing desk control channels. Thus for example the first vocalist visual representation 311 is linked visually to the first audio mixing desk channel 321 and the second vocalist visual representation 313 is linked visually to the sixth first audio mixing desk channel 323. In some embodiments the ordering of the mixing desk channels can be user adjustable. Furthermore in some embodiments the user may use the user interface to assign the channels to the sources or they may be automatically assigned.

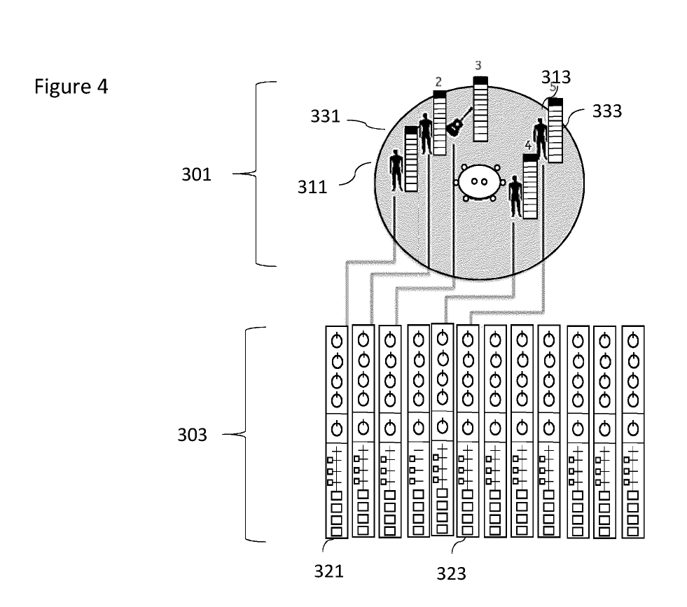

With respect to FIG. 4, the visual representation shown in FIG. 3 is changed by the user interface being configured to display a further overlay comprising visual representation of VU meters associated with the sources for easy monitoring of the sources. Thus the first vocalist visual representation 311 has an associated VU meter 331 and the second vocalist visual representation 313 has an associated VU meter 333.

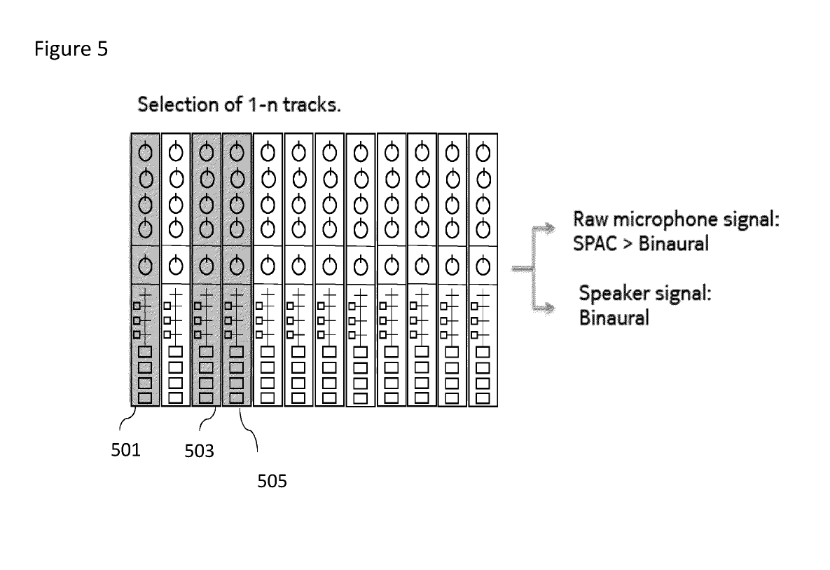

With respect to FIG. 5, the visual representation of the mixing desk control part 303 as generated by the UI may furthermore comprise a highlighting effect configured to identify which sources are raw microphone signals (and thus require SPAC and binaural rendering) and which are speaker signals (and thus only require rendering). For example in FIG. 5 the first, third and fourth audio mixing desk channels 501, 503 and 505 are highlighted as raw microphone sources. In other words enabling SPAC processing for raw microphone signals.

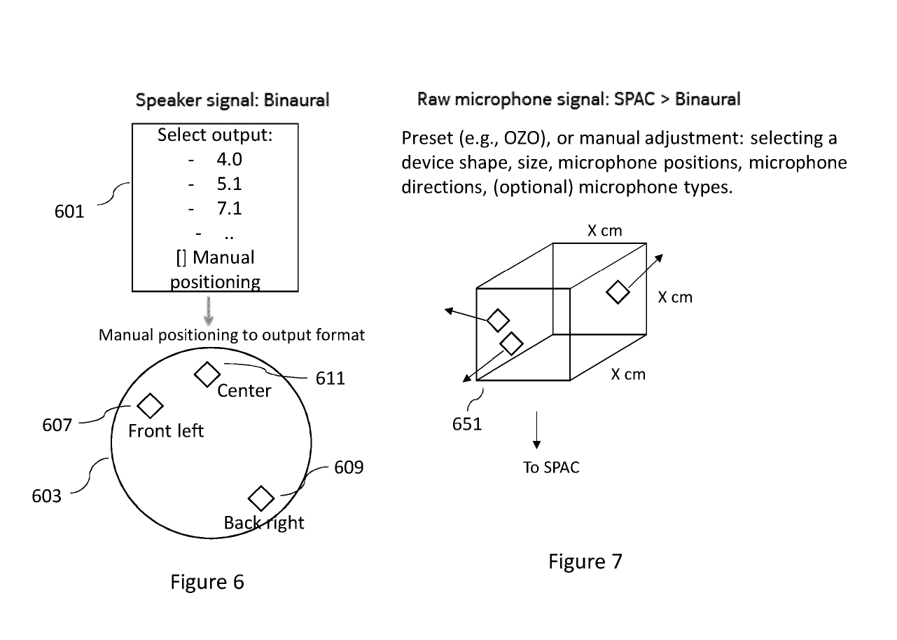

With respect to FIG. 6, a further user interface visualisation for representing defined and manual positioning of audio sources for the highlighted speaker channel audio signals is shown. Thus for speaker signals where binaural rendering is required the UI may generate an output selection menu 601 comprising a list of predefined position format outputs. Furthermore in some embodiments the UI may enable a manual positioning option which generates a manual positioning 603 window to be displayed on which it is possible to manually input speaker output locations. For example as shown in FIG. 6 there may be front left 607, center 611 and back right 609 position which can be used to determine the output rendering.

FIG. 7 shows a further user interface visualisation for representing defined and manual positioning of audio sources for the raw microphone signals. Such a visualisation 651 shows a preset or manual adjustment by selecting a device size, and microphone position, and/or microphone direction and/or microphone type.

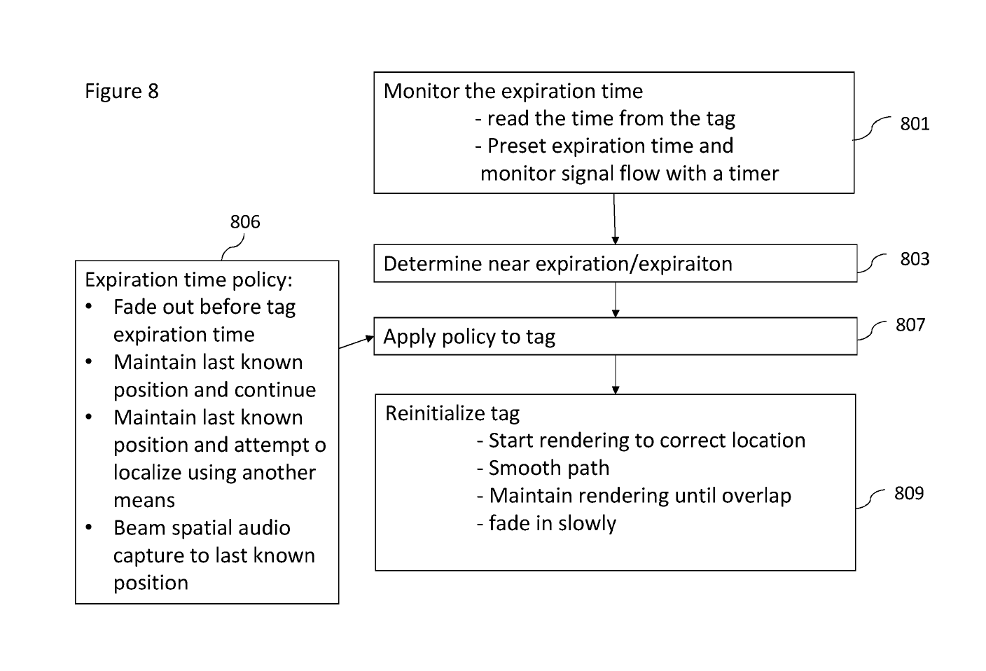

With respect to FIG. 8 is shown a summary of operations with respect to some embodiments for controlling the tracking in situations such as location tag time expiration.

The location (positioning) tags may be configured to expire after a certain amount of time. This time may be reinitialized or extended by pressing a physical button on the tag. To prevent the tag expiring during a performance or when a location signal is not received temporarily for some reason (blockage etc.) the tracker manager may be configured to perform the following operations.

Firstly the tracker manager may be configured to monitor any identified tags and the associated expiration time.

The expiration time can be monitored in one or more of the following ways. Firstly the expiration time may be read from the tag directly or be included in the tag properties transmitted by the tag. In some embodiments the expiration time is defined as a preset expiration time and the signal flow is associated with a timer.

The monitoring of the expiration time is shown in FIG. 8 by step 801.

In some embodiments the tag expiration time may not be extended (i.e. the tag is a temporary tag).

Furthermore in some embodiments the user can be provided with an indication (vibra, sound etc.) identifying when the tag time is about to run out.

In some embodiments the tracker monitor may determine that the tag time is near expiration or expiration has occurred.

The operation of determining near expiration or expiration has occurred is shown in FIG. 8 by step 803.

In some embodiments the tracker manager may be configured to define an expiration time policy. Thus may for example be chosen from a user interface list of available options. Example selectable expiration time policies may be

1) Fade out audio before the tag time runs out.

2) Maintain the last known position and continue rendering the audio there.

3) Maintain the last known position and try alternative localization methods: audio, visual. With audio, the source may be recognized from the audio scene of the spatial audio capture system, using the close-up microphone signal as a guiding method/seed to search for. From the spatial audio capture system it is then possible to derive a direction of arrival with acceptable precision. In our Smart Audio Mixing system, visual tracking is used to complement the positioning positioning and to provide additional data of the source. In some cases, the visual tracking system may temporarily replace the positioning location estimates and continue tracking the source.

4) Apply audio beamforming techniques to focus the audio capture of the spatial audio capture device the to the last known position of the source.

The defining of a policy is shown in FIG. 8 by step 806.

The tracker manager may apply the policy to the tag processing.

The application of the policy to the tag is shown in FIG. 8 by step 807.

In some embodiments the tracker manager may re-initialize a tag (for example following a press of the tag button generating a new tag expiration time). The initialization of the tag may furthermore cause the tracker manager to perform at least one of the following (which may be defined or controlled by a user interface input):

1) Start rendering to correct location when the connection is re-established

2) Smooth the path towards the correct location with a set maximum speed

3) Maintain rendering in the previous position until the current position overlaps and then resume tracking

4) Control the Fade-in for the associated audio slowly.

The operation of initialization of the tag is shown in FIG. 8 by step 809.

The operations explained in conjunction with re-initialization of the positioning tag, can also be applied while using visual or audio analysis based external sound source tracking. This is particularly important for situations with varying illumination or with poor illumination condition.

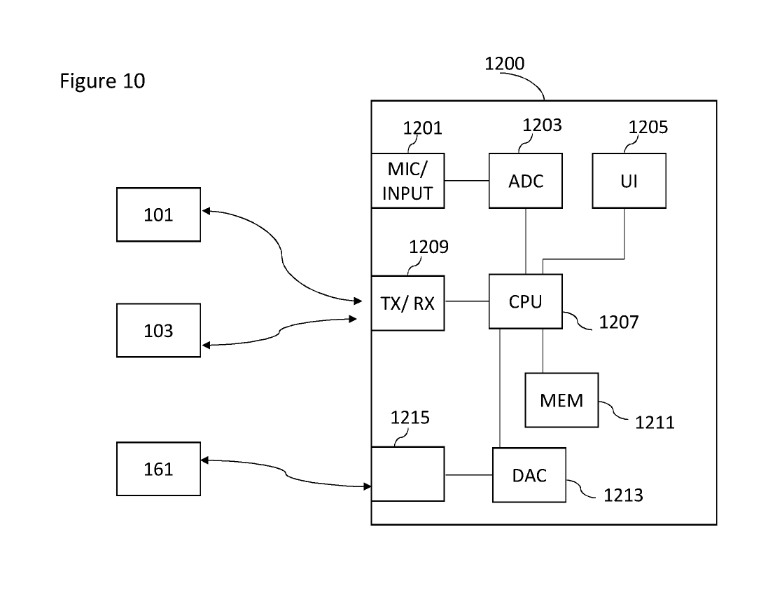

With respect to FIG. 10 an example electronic device which may be used as at least part of the external capture apparatus 101, 103 or 105 or OCC capture apparatus 141, or mixer/renderer 151 or the playback apparatus 161 is shown. The device may be any suitable electronics device or apparatus. For example in some embodiments the device 1200 is a mobile device, user equipment, tablet computer, computer, audio playback apparatus, etc.

The device 1200 may comprise a microphone array 1201. The microphone array 1201 may comprise a plurality (for example a number N) of microphones. However it is understood that there may be any suitable configuration of microphones and any suitable number of microphones. In some embodiments the microphone array 1201 is separate from the apparatus and the audio signals transmitted to the apparatus by a wired or wireless coupling. The microphone array 1201 may in some embodiments be the microphone 113, 123, 133, or microphone array 145 as shown in FIG. 9.

The microphones may be transducers configured to convert acoustic waves into suitable electrical audio signals. In some embodiments the microphones can be solid state microphones. In other words the microphones may be capable of capturing audio signals and outputting a suitable digital format signal. In some other embodiments the microphones or microphone array 1201 can comprise any suitable microphone or audio capture means, for example a condenser microphone, capacitor microphone, electrostatic microphone, Electret condenser microphone, dynamic microphone, ribbon microphone, carbon microphone, piezoelectric microphone, or microelectrical-mechanical system (MEMS) microphone. The microphones can in some embodiments output the audio captured signal to an analogue-to-digital converter (ADC) 1203.

The device 1200 may further comprise an analogue-to-digital converter 1203. The analogue-to-digital converter 1203 may be configured to receive the audio signals from each of the microphones in the microphone array 1201 and convert them into a format suitable for processing. In some embodiments where the microphones are integrated microphones the analogue-to-digital converter is not required. The analogue-to-digital converter 1203 can be any suitable analogue-to-digital conversion or processing means. The analogue-to-digital converter 1203 may be configured to output the digital representations of the audio signals to a processor 1207 or to a memory 1211.

In some embodiments the device 1200 comprises at least one processor or central processing unit 1207. The processor 1207 can be configured to execute various program codes. The implemented program codes can comprise, for example, SPAC control, position determination and tracking and other code routines such as described herein.

In some embodiments the device 1200 comprises a memory 1211. In some embodiments the at least one processor 1207 is coupled to the memory 1211. The memory 1211 can be any suitable storage means. In some embodiments the memory 1211 comprises a program code section for storing program codes implementable upon the processor 1207. Furthermore in some embodiments the memory 1211 can further comprise a stored data section for storing data, for example data that has been processed or to be processed in accordance with the embodiments as described herein. The implemented program code stored within the program code section and the data stored within the stored data section can be retrieved by the processor 1207 whenever needed via the memory-processor coupling.

In some embodiments the device 1200 comprises a user interface 1205. The user interface 1205 can be coupled in some embodiments to the processor 1207. In some embodiments the processor 1207 can control the operation of the user interface 1205 and receive inputs from the user interface 1205. In some embodiments the user interface 1205 can enable a user to input commands to the device 1200, for example via a keypad. In some embodiments the user interface 205 can enable the user to obtain information from the device 1200. For example the user interface 1205 may comprise a display configured to display information from the device 1200 to the user. The user interface 1205 can in some embodiments comprise a touch screen or touch interface capable of both enabling information to be entered to the device 1200 and further displaying information to the user of the device 1200.

In some implements the device 1200 comprises a transceiver 1209. The transceiver 1209 in such embodiments can be coupled to the processor 1207 and configured to enable a communication with other apparatus or electronic devices, for example via a wireless communications network. The transceiver 1209 or any suitable transceiver or transmitter and/or receiver means can in some embodiments be configured to communicate with other electronic devices or apparatus via a wire or wired coupling.

For example as shown in FIG. 10 the transceiver 1209 may be configured to communicate with a playback apparatus 103.

The transceiver 1209 can communicate with further apparatus by any suitable known communications protocol. For example in some embodiments the transceiver 209 or transceiver means can use a suitable universal mobile telecommunications system (UMTS) protocol, a wireless local area network (WLAN) protocol such as for example IEEE 802.X, a suitable short-range radio frequency communication protocol such as Bluetooth, or infrared data communication pathway (IRDA).

In some embodiments the device 1200 may be employed as a render apparatus. As such the transceiver 1209 may be configured to receive the audio signals and positional information from the capture apparatus 101, and generate a suitable audio signal rendering by using the processor 1207 executing suitable code. The device 1200 may comprise a digital-to-analogue converter 1213. The digital-to-analogue converter 1213 may be coupled to the processor 1207 and/or memory 1211 and be configured to convert digital representations of audio signals (such as from the processor 1207 following an audio rendering of the audio signals as described herein) to a suitable analogue format suitable for presentation via an audio subsystem output. The digital-to-analogue converter (DAC) 1213 or signal processing means can in some embodiments be any suitable DAC technology.

Furthermore the device 1200 can comprise in some embodiments an audio subsystem output 1215. An example, such as shown in FIG. 10, may be where the audio subsystem output 1215 is an output socket configured to enabling a coupling with the headphones 161. However the audio subsystem output 1215 may be any suitable audio output or a connection to an audio output. For example the audio subsystem output 1215 may be a connection to a multichannel speaker system.

In some embodiments the digital to analogue converter 1213 and audio subsystem 1215 may be implemented within a physically separate output device. For example the DAC 1213 and audio subsystem 1215 may be implemented as cordless earphones communicating with the device 1200 via the transceiver 1209.

Although the device 1200 is shown having both audio capture and audio rendering components, it would be understood that in some embodiments the device 1200 can comprise just the audio capture or audio render apparatus elements.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1. Apparatus comprising:
a locator configured to determine at least one audio source location associated with at least one audio source signal;
a user interface configured to generate at least one user interface element associated with the at least one audio source signal, the user interface further configured to receive at least one user interface input associated with the user interface element;
a controller configured to manage control of at least one parameter associated with the determined at least one audio source signal based on the at least one user interface input; and
a processor configured to control audio source signal processing based on the determined audio source location and the at least one parameter.

2. The apparatus as claimed in claim 1, wherein the locator comprises at least one of:
a radio based positioning locator configured to determine a radio based positioning based audio source location estimate;
a visual locator configured to determine a visual based audio source location estimate; and
an audio locator configured to determine an audio based audio source location estimate.

3. The apparatus as claimed in claim 1, wherein the user interface is configured to generate a visual representation identifying the audio source signal located at a position based on the determined audio source location.

4. The apparatus as claimed in claim 3, wherein the user interface is configured to generate a source type selection menu to enable an input to identify the at least one audio source signal type wherein the visual representation identifying the audio source located at a position based on the determined audio source location is determined based on a selected item from the source signal type selection menu.

5. The apparatus as claimed in claim 1, wherein the user interface is configured to generate a tracking control selection menu; and the user interface configured to receive at least one user interface input associated with the user interface element is configured to receive at least one audio source tracking profile from the tracking control selection menu, wherein the controller is configured to manage tracking of the determined audio source location based on the audio source tracking profile from the tracking control selection menu.

6. The apparatus as claimed in claim 1, wherein the user interface is configured to generate a tag position visual representation enabling the user to define a tag position on a visual representation; and wherein the controller is configured to manage tracking of the determined audio source location based on a positional offset defined by the tag position on the visual representation.

7. The apparatus as claimed in claim 1, wherein the user interface is configured to generate at least one of:
a mixing desk visual representation comprising a plurality of audio channels, and a visual representation linking an audio channel from the mixing desk visual representation to the at least one user interface element associated with the at least one audio source signal; and
at least one meter visual representation, and associate the at least one meter visual representation with the at least one user interface element associated with the at least one audio source signal.

8. The apparatus as claimed in claim 7, wherein the user interface is configured to:
highlight any audio channels of the mixing desk visual representation linked with the at least one user interface element associated with the at least one audio source in a first highlighting effect; and
highlight any audio channels of the mixing desk visual representation associated with an output channel in a second highlighting effect.

9. The apparatus as claimed in claim 1, wherein the user interface is configured to generate at least one of:
a user interface control enabling the definition of a rendering output format, wherein the processor is configured to control audio source signal processing based on the determined audio source location is further based on the rending output format definition; and
a user interface control enabling the definition of a spatial processing operation, wherein the processor is configured to control audio source signal processing based on the determined audio source location is further based on a spatial processing definition.

10-11. (canceled)

12. The apparatus as claimed in claim 1, wherein the controller is configured to manage control of at least one parameter associated with the determined at least one audio source signal based on the at least one user interface input in real time.

13. The apparatus as claimed in claim 1, wherein the audio source is associated with at least one remote microphone configured to generate at least one remote audio signal from the audio source, wherein the apparatus is configured to at least one of:
receive the at least one remote audio signal; and
transmit the determined audio source location to a further apparatus, the further apparatus configured to receive the remote audio signal.

14. A method comprising:
determining at least one audio source location associated with at least one audio source signal;
generating at least one user interface element associated with the at least one audio source signal;
receiving at least one user interface input associated with the user interface element;
managing control of at least one parameter associated with the determined at least one audio source signal based on the at least one user interface input; and
controlling audio source signal processing based on the determined audio source location and the at least one parameter.

15. The method as claimed in claim 14, wherein determining at least one audio source location comprises at least one of:
determining a radio based positioning based audio source location estimate;
determining a visual based audio source location estimate; and
determining an audio based audio source location estimate.

16. The method as claimed in claim 14, wherein generating at least one user interface element associated with the at least one audio source signal comprises generating:
a visual representation identifying the audio source signal located at a position based on the determined audio source location; and
a source type selection menu to enable an input to identify an at least one audio source signal type wherein generating the visual representation identifying the audio source signal located at a position based on the determined audio source location comprises generating the visual representation based on a selected item from the source signal type selection menu.

17. The method as claimed in claim 14, wherein
generating at least one user interface element associated with the at least one audio source signal comprises generating a tracking control selection menu,
receiving at least one user interface input associated with the user interface element comprises inputting at least one audio source tracking profile from the tracking control selection menu, and
managing control of at least one parameter associated with the determined at least one audio source based on the at least one user interface input comprises managing tracking of the determined audio source location based on the audio source tracking profile from the tracking control selection menu.

18. The method as claimed in claim 14, wherein generating at least one user interface element associated with the at least one audio source signal comprises generating a tag position visual representation enabling the user to define a tag position on a visual representation; and managing control of at least one parameter associated with the determined at least one audio source based on the at least one user interface input comprises managing tracking of the determined audio source location based on a positional offset defined by the selected tag position on the visual representation.

19. The method as claimed in claim 14, wherein generating at least one user interface element associated with the at least one audio source signal comprises generating at least one of:
a mixing desk visual representation comprising a plurality of audio channels, and a visual representation linking an audio channel from the mixing desk visual representation to the at least one user interface element visual associated with the at least one audio source signal; and
at least one meter visual representation, and associating the at least one meter visual representation with the at least one user interface element associated with the at least one audio source signal.

20. The method as claimed in claim 19, wherein generating at least one user interface element associated with the at least one audio source signal comprises:
highlighting any audio channels of the mixing desk visual representation linked with the at least one user interface element associated with the at least one audio source in a first highlighting effect; and
highlighting any audio channels of the mixing desk visual representation associated with an output channel in a second highlighting effect.

21. The method as claimed in claim 14, wherein generating at least one user interface element associated with the at least one audio source signal comprises generating at least one of:
a user interface control enabling the definition of a rendering output format, wherein controlling audio source signal processing based on the determined audio source location comprises controlling audio source processing further based on the rending output format definition; and
a user interface control enabling the definition of a spatial processing operation, wherein controlling audio source signal processing based on the determined audio source location comprises controlling audio source processing further based on the spatial processing definition.

22. The method as claimed in claim 14, wherein managing control of at least one parameter associated with the determined at least one audio source signal further comprises managing control of at least one parameter associated with the determined at least one audio source signal based on the at least one user interface input in real time.

23-25. (canceled)
